(19) United States
(12) Patent Application Publication
(10) Pub. No.: US 2006/0101160 A1
(43) Pub. Date: May 11, 2006

(54) Methods, systems and computer program products for expressing classes of adaptation and classes of content in media transcoding

(75) Inventor: Stephane Coulombe, Brossard (CA)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/297,940

(22) Filed: Dec. 9, 2005

Related U.S. Application Data
(63) Continuation-in-part of application No. 11/158,610, filed on Jun. 22, 2005.
(60) Provisional application No. 60/582,218, filed on Jun. 23, 2004.

(51) Int. Cl. G06F 15/16

(52) U.S. Cl. 709/246; 709/227

(57) ABSTRACT

A generic method and means for defining and identifying classes of adaptation and classes of content in transcoding processes. The generic nature of the method and means allow for description of large quantity of adaptation and content classes, which would accommodate MMS, as well as other network applications. In addition, the method and means provide for a network application to communicate the defined classes of adaptation to a transcoding routine along with an indication as to whether adaptation of media content falling into such classifications are permitted or denied. The method and means also provide for the transcoding routine to communicate to the network application information about the adaptation performed in relation to the classification. The invention also provides for classification of the content of media elements both prior to and post adaptation.

### CROSS REFERENCE TO RELATED APPLICATIONS

This application is a continuation-in-part of U.S. patent application Ser. No. 11/158,610, filed Jun. 22, 2005, which claims the benefit of U.S. Provisional Patent Application No. 60/582,218, filed Jun. 23, 2004, both of which are incorporated herein in their entireties.

### FIELD OF THE INVENTION

The present invention relates generally to media transcoding and, more particularly, to methods, systems and computer program products for expressing classes of adaptation performed in conjunction with the Open Mobile Alliance (OMA) Standard Transcoding Interface (STI).

### BACKGROUND OF THE INVENTION

In network communication the process of converting or adapting a media file or object from one format to another format is commonly referred to as transcoding. Transcoding is often used to convert video formats (i.e., QuickTime to MPEG) or to change the resolution of image files. However, transcoding is also used to fit HyperText Markup Language (HTML) files and graphic files to the unique constraints of mobile devices and other Web-enabled products. Typically, mobile devices have different display sizes, amount of memory and different bandwidth rates. All of these factors contribute to the need to transcode data that is communicated to and from mobile devices. The process of transcoding is performed at a transcoding proxy server or at a similar network device. The server receives the requested message or file and executes a transcoding routine to adapt the message or file to the requirements of the receiving device/client.

Currently, each specific network application performs an application-specific transcoding routine at a network application server. For example, Multimedia Messaging Service (MMS) transcoding is performed at an MMS Center (MMSC) executing an MMS-specific transcoding routine. However, current innovations are underway that would make it possible to perform multiple transcoding functions, for numerous network applications, at a separate network transcoding server that serves many different transcoding applications. For example, the transcoding server would accommodate MMS, browsing (i.e., web portal), Session Initiation Protocol (SIP)—based messaging, download servers and the like.

This type of application-generic transcoding is being made possible by a Standard Transcoding Interface (STI) that has been developed by the Open Mobile Alliance (OMA). The STI is a standard interface between a network application and a transcoding platform. More particularly, the STI is a Simple Object Access Protocol (SOAP)-based interface running over HTTP/TCP (Transmission Control Protocol)/IP (Internet Protocol). The STI provides the functionality whereby an application can provide multipart content or individual media elements and specify a target device type for which the content shall be adapted. The STI also offers functionality where multipart or individual media elements are provided for adaptation with very specific transcoding parameters (e.g., target image resolution, target media size, target MIME (Multipurpose Internet Mail Extensions) format, etc).

However, since a requirement of the STI is that it should be application agnostic, in other words, work in a general fashion independent of the specific application requesting transcoding, the STI currently does not allow for any information related to the application-specific nature or classification of the transcoding operation performed to be communicated to the application. In many instances, the application requires such information in order to make decisions regarding further processing and communicating the message or file. For example, requirements exist in the OMA MMS standard related to the behavior of the Multimedia Messaging Service Center (MMSC) depending on the type of adaptation performed. Specifically, if the transcoding is determined to be of a major classification the MMSC shall provide means to the MMS service provider to enable or disable the major content adaptation function. Additionally, in an instance in which a major content adaptation needs to be applied to a multimedia message, the original content of the message should be available to the end-user through subsequent MMS transactions or by other means, such as web or Internet Message Access Protocol (IMAP) interface storage or forwarding to email. In addition, since the STI has no knowledge of adaptation classification and, as such, can not provide the application with adaptation classification information, the MMSC does not have any means to tell if a major adaptation is not permitted.

Additionally, the STI has a mode in which a network application can send a full MMS message and specify a target device for which the message shall be adapted. In this situation, the MMSC would benefit from knowing the message class of the content that it sent to the transcoding routine and the content it receives back from the transcoding routine. The MMSC may desire message class information for billing purposes or for special actions after adaptation of the message, such as communicating a copy of the original content to a storage server if the message was adapted from a higher message class to a lower message class. However, the generic nature of the STI currently does not provide for the inclusion of purely MMS-specific information, such as MMS classes, in the interface.

The need for adaptation classification notification is not limited to the MMS application example provided above. Other applications also possess the need to be able to classify adaptation operations, communicate to the transcode routine which adaptations are permissible and/or learn the specifics of the adaptation that has been performed. For instance, a web browsing application may need to know if the layout format of some of the content has been altered (e.g., if HTML is converted to Synchronized Multimedia Integration Language (SMIL)). In such an instance, the web browsing application would need to communicate to the transcoding routine the properties of a “layout format conversion.”

Since the STI is application agnostic, it is not possible to hardwire a certain parameter as being “major” or “minor,” or any other classification distinction, because each parameter may be defined differently depending on the application. Additionally, classification could be defined as proprietary interface extensions and logic; however this option would be against the goals of standardizing the entire media transcoding process.

While it is possible for an application server, such as an MMSC, to perform a comparison between the content submitted to the transcoding routine and the adapted content to determine the classification type of the adaptation, the server would still typically require a complex software routine to determine the nature or classification of the adaptation.

Therefore a need exists to develop methods and means for identifying properties and/or classification types of adaptations conducted by a transcoding routine. As such, the desired methods and means shall inform the transcoding routine through STI, or other means, what are the characteristics of different adaptation classes. In addition, the desired methods and means shall inform the transcoding routine, typically through the STI, which classes of adaptation are permitted and which are not permitted. It is also desirable for the methods and means to receive from the transcoding routine information regarding the classes of adaptation performed. The desired methods and means will provide for implementation at a network server/node or at the user terminal level. The desired methods and means will also be able to be implemented using very generic mechanisms that allow for identification and classification without requiring a complex software routine for analyzing the adapted content. Also, the desired methods and means would benefit from being able to provide a generic mechanism within the STI to define content classes and to communicate to the application platform the content class of adapted and yet-to-be adapted content.

### SUMMARY OF THE INVENTION

The present invention provides for generic methods and computer program products for defining classes of adaptation based of adaptation properties for subsequent implementation in application-generic transcoding operations. In addition, a method and computer program product is provided for defining transcoding permissibility based on the class of adaptation. The invention also provides for a method and computer program product for defining the content of the media item classifications for subsequent implementation in application-generic transcoding operations.

In one embodiment of the invention a method for communicating adaptation classification in an application-generic transcoding environment is defined. The method includes the steps of providing one more classes of adaptation at an application-generic transcoding platform. Each class of adaptation will include a name for the class, such as “major,” “minor” or any other suitable defining name. The class of adaptation may also be defined by optional properties such as a list of input/output pairs, a rule, transcoding permission, an include list and/or an exclude list. The application-generic transcoding platform will support multiple transcoding functions such as MMS, browsing, Session Initiation Protocol (SIP) messaging, downloading and the like. To accommodate such application-generic transcoding the media element and the classes of adaptation may be communicated through a Standard Transcoding Interface, such as, by example the STI developed by the Open Mobile Alliance (OMA).

The method further provides for a transcoding operation at the transcoding platform to execute the required adaptation on at least one media element. Media elements to be adapted may include but are not limited to Multimedia Messaging Service (MMS) messages, video file, HTML files, graphic files or the like. Once the transcoding operations have been performed, the method concludes by communicating adaptation class-related information including information related to one or more classes of adaptation to which the media element(s) were subjected during execution of the transcoding operation. This information is typically communicated to network applications, executed at the web portal, the MMS Center, other messaging center or the like.

The invention is also defined by a method for determining adaptation permissibility in an application-generic transcoding environment. The method includes the step of receiving adaptation permissibility properties for one or more classes of adaptation, the adaptation permissibility properties being received at an application-generic transcoding platform. The method may also include communicating a media element and adaptation parameters (or terminal characteristics) to the transcoding platform. The method may also include determining adaptation permissibility for the communicated media element based on communicated adaptation permissibility properties and, if so desired, adaptation parameters (or terminal characteristics). A transcoding operation is then executed at the transcoding platform in accordance with the determined adaptation permissibility. Adaptation permissibility describes if the adaptations belonging to a specific class are allowed or forbidden. Adaptation may be forbidden if the transcoding operations to be performed on the media elements would belong to any one class which has been determined to be forbidden.

The invention may also be defined by a method for classifying content in media elements in an application-generic transcoding platform. The method includes the steps of providing one or more classes for content in media elements at an application-generic transcoding platform, the classes having been defined based on properties, such as class name, a list of media content belonging to the class, a rule and a size limit. Once the classes are provided, the method includes executing a content analysis operation on content in one or more media elements. In this regard, the content analysis operation is performed to determine one or more input classes of the content (“input” designating the class of content before executing a transcoding operation), and/or one or more output classes of the content (“output” designating the class of content after executing the transcoding operation). Once the content analysis operation is performed, information related the input and/or output classes of the content are communicated to the network application.

Additionally, the invention is defined by computer program products. One of the embodiments encompasses a computer program product for communicating the classes to an application-generic transcoding platform. The product includes a computer readable storage medium having computer-readable program instructions embodied in the medium. The computer-readable program instructions include first instructions for providing one or more classes of adaptation at an application-generic transcoding platform. The computer-readable program instructions may include second instructions for executing a transcoding operation on one or more media elements. The computer-readable program instructions may additionally include third instructions for communicating, to a network application, adaptation class-related information including information related to one or more classes of adaptation to which the media element(s) were subjected during execution of the transcoding operation.

In another embodiment is defined by a computer program product for determining adaptation permissibility in an application-generic transcoding environment. The product includes a computer readable storage medium having computer-readable program instructions embodied in the medium. The computer-readable program instructions include first instructions for receiving adaptation permissibility properties for one or more classes of adaptation, the properties being received at an application-generic transcoding platform. The computer-readable program instructions may also include second instructions for determining adaptation permissibility for one or more media elements based on the received adaptation permissibility properties. Further, the computer-readable program may include third instructions executing a transcoding operation at the transcoding platform on the media element(s), where the transcoding operation is performed in accordance with the determined adaptation permissibility.

Yet another embodiment is defined by a computer program product for determining media element content class in an application-generic transcoding environment. The product includes a computer readable storage medium having computer-readable program instructions embodied in the medium. The computer-readable program instructions include first instructions for providing one or more classes for content in media elements, the content classes being provided at an application-generic transcoding platform. The computer-readable program instructions may include second instructions for executing a content analysis operation at the transcoding platform on content in one or more media elements. In this regard, the content analysis operation is performed to determine one or more input classes of the content, and/or one or more output classes of the content. The computer-readable program instructions may also include third instructions for communicating information related to the input and/or output classes of the content.

As such, the invention proposes a generic framework allowing an application to describe “adaptation classes” and their properties. The framework can describe the properties of “minor” and “major” adaptations for MMS application. Because the framework is general, the invention can describe other adaptation classes of interest in other applications (e.g., describing the properties of a layout adaptation or a video to image adaptation class). The invention framework also provides the functionality to tell the transcoding platform if those classes of adaptation are permitted or not. This functionality is useful to certain applications, such as MMS, to provide major adaptation disablement functionality. The invention also provides for the transcoding platform to return along with the adapted content, information about the classes of adaptations performed (e.g., if a minor or major adaptation was performed).

The invention also proposes a generic framework allowing an application to describe “media element content classes” and their properties. For example, the framework can describe the properties of “VideoBasic” and “VideoRich” content classes for a MMS application. Because the framework is general, the invention can describe other content classes of interest in other applications. The invention framework provides the functionality to describe the characteristics of such content classes to the transcoding platform. The invention also provides for the transcoding platform to return, along with the adapted content, information about the content classes encountered at input and at output (e.g., if the input was a VideoRich and the output was a VideoBasic).

### BRIEF DESCRIPTION OF THE DRAWINGS

Having thus described the invention in general terms, reference will now be made to the accompanying drawings, which are not necessarily drawn to scale.

FIG. 1 is a block diagram of a wireless network having various network applications that implement a transcoding routine in conjunction with a standard transcoding interface, in accordance with an embodiment of the present invention.

FIG. 2 is a flow diagram depicting a method for defining and communicating classes of adaptation in an application-generic transcoding environment, in accordance with an embodiment of the present invention.

FIG. 3 is a flow diagram depicting a method for defining adaptation permissibility properties and determining adaptation permissibility in an application-generic transcoding environment, in accordance with an embodiment of the present invention.

FIG. 4 is a flow diagram depicting a method for defining and communication classes of content in media elements in an application-generic transcoding environment, in accordance with an embodiment of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

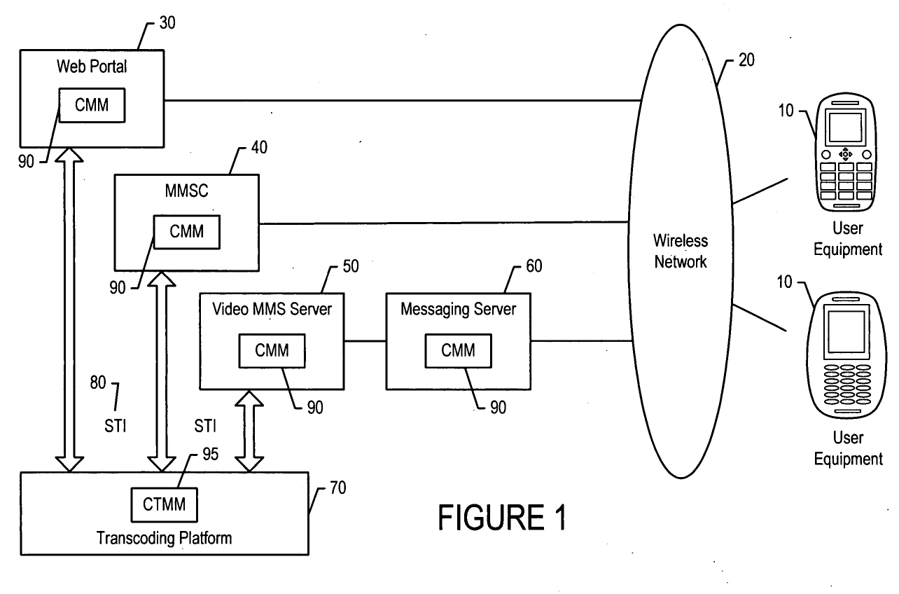

Referring now to FIG. 1, a block diagram of service deployment in a wireless communication network using a Standard Transcoding Interface (STI) is shown in accordance with an embodiment of the present invention. Mobile terminals 10 (shown as “user equipment”) will communicate wirelessly through wireless network 20. The mobile terminals may be afforded access to various network applications through the wireless network. These network applications, include, but are not limited to, web browsing via web portal 30, Multimedia Messaging Service (MMS) via MMS Center (MMSC) 40, video MMS via video MMS server 50 and corresponding messaging server 60. Information, such as messages and files, that is communicated to the mobile terminals will typically require some form of transcoding prior to being delivered to the mobile terminal. Transcoding provides for the messages and/or files to be reformatted into formats and characteristics best suited for the appropriate mobile terminal. In the illustrated embodiment, all of the network applications perform transcoding in accordance with transcoding platforms executed at transcoding server 70. A standard transcoding interface (STI) 80 exists between the applications and the transcoding platforms.

In addition, one or more class management modules (CMMs) 90 (otherwise referred to as classification of adaptation and content applications) can be implemented between the network application servers 30, 40, 50 and 60 and the transcoding server 70. In this regard, the class management modules can be integral with the network application servers, as shown, or alternatively distributed from and in communication with the network application servers. The class management modules can describe and communicate (e.g., within an STI request) information about classes of content, classes of adaptation and if they are permitted or not to the transcoding server 70. The class management modules can also be responsible for analyzing the information returned by the transcoding server 70 regarding the input/output content classes and adaptation classes performed, and triggering appropriate actions based on the information. Transcoding server 70 can be integral or otherwise in communication with a class transcoding management module (CTMM) 95 that can analyze the described content and adaptation classes, ensure the transcoding platform doesn't perform disallowed transcoding, obtain input and output content classes data and inform application servers 30, 40, 50 and 60 about the input and output content classes as well as adaptation classes performed. Further, although the class management modules are described above as describing information about classes of content and classes of adaptation, it should be understood that one or more classes of content and/or one or more classes of adaptation may be defined within the transcoding server, such as within the class transcoding management module, without departing from the spirit and scope of the present invention.

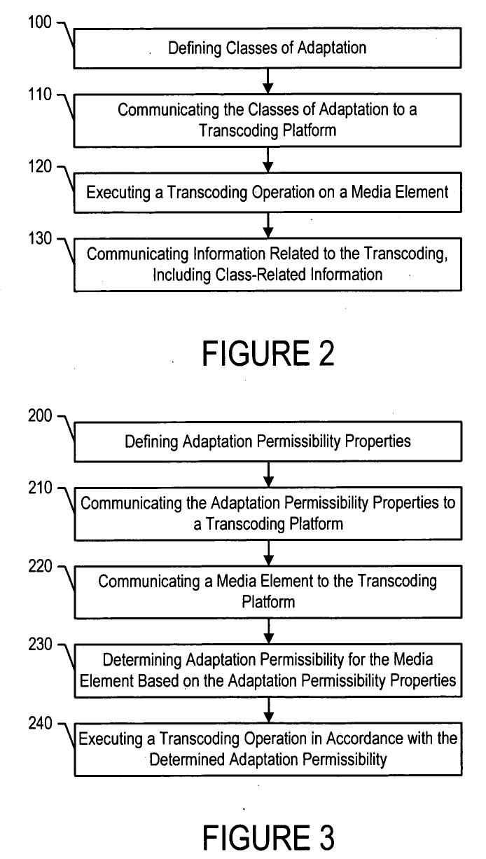

FIG. 2 is a simplified flow diagram of a method for defining and communicating classes of adaptation in a transcoding process, in accordance with an embodiment of the present invention. At step 100, classes of adaptation are defined according to the properties associated with the classes. The classes of adaptation may be defined within the network application, although it should be understood that one or more classes of adaptation may alternatively be defined within the transcoding server. At step 110, the classes of adaptation, or at least those defined within the network application, are communicated to an application-generic transcoding platform, typically through a Standard Transcode Interface (STI). Thus, the classes of adaptation may be provided at the transcoding platform, such as by being defined and communicated from the network application and/or by being defined within the transcoding platform. At step 120, a transcoding application at the platform is executed on a media element and, at step 130, information related to the transcoding performed on the media element is communicated from the platform to a network application, the information including class-related information, such as the classes of adaptation with which the performed transcoding are associated.

In accordance with one embodiment of the invention, classes of adaptation are defined by describing the properties. The description of the “classes of adaptation” are generic enough such that new classes may be defined in the future to accommodate new requirements of any applications, including new requirements of the MMS standard and the like.

In one embodiment of the invention Extensible Mark-up Language (XML) is used to describe the classes of adaptation and to define which classes of adaptation are permissible. However any manner of representing the same information is within the inventive concepts herein disclosed.

The properties of classes of adaptation may include but are not limited to the following properties: 1) a Name for the Class described, typically a required property; 2) a List of Input/Output Pairs, typically an optional property; 3) a Rule, typically an optional property; 4) a Transcode Permission, typically an optional property; and 5) an Include List and an Exclude List, typically an optional property. The following is a description of each of the adaptation properties:

Class Name

The class name is the name given to the class of adaptation described. For example, depending on the application, the class name may be “major,” “minor” or any other name, such as “layoutAdaptation,” “videoToImage,” “xyz” or the like. In the MMS environment the classes may be defined as “major” and “minor” and in the web environment the classes may be defined as “layoutAdaptation” and “videoToImage.”

List of Input/Output Pairs

The input refers to the content type that the transcoding routine receives from the network application. The output refers to the content type that the transcoding platform returns to the network application, typically adapted output content. Typically, the Input/Output pair will include a pair of input Multi-Purpose Internet Mail Extensions (MIME) and output MIME describing the relationship between the output and a given input. The pair may represent a format conversion operation (when both are different), or adaptation within the same format (when both are the same). For instance the following describes an input/output pair for a GIF (Graphic Interchange Format) to JPEG (Joint Photographic Expert Group) conversion:

<input> image/gif </input>
<output> image/jpeg </output>

In this same regard, the following represents a possible adaptation (e.g., resolution or file size reduction) of JPEG within the same format:

<input> image/jpeg </input>
<output> image/jpeg </output>

It is noted that the output listing is not limited to one output but rather may include multiple outputs. Multiple outputs indicate that the input is converted to any one of the listed outputs. For example, for a WBMP (Wireless BitMap) to GIF or JPEG conversion:

<input> image/wbmp</input>
<output> image/gif, image/jpeg </output>

Alternatively, for a video/3GPP (3rd Generation Partnership Project) to GIF and/or AMR (Adaptive Multirate) clip:

<input> video/3gpp </input>
<output> image/gif, audio/amr </output>

Similarly, the method can list multiple input formats converted to one or more outputs. For example, for a WBMP or JPEG to GIF or JPEG conversion:

<input> image/wbmp, image/jpeg </input>
<output> image/gif, image/jpeg </output>

The asterisk mechanism (*) in MIME language can also be used to indicate any acceptable media types or media formats. For instance, the adaptation of any video format to any image format would be expressed as:

<input> video/* </input>
<output> image/* </output>

Similarly, the adaptation of any media type to JPEG would be expressed as:

<input> * </input>
<output> image/jpeg </output>

Finally, deletion of content may be represented with an empty output. For instance, deletion of images can be represented as:

<input> image/* </input>
<output> </output>

Rule

The rule portion of the properties list is significant if the message to be adapted includes multiple media elements. The rule portion defines how the input/output pair information for each media element to be adapted is processed to determine the adaptation class when the transcoding routine reports the classes of adaptations performed. In one embodiment the possible values for the rule are “condition met for all” and “condition met for at least one.”

Under the “condition met for all” rule, the adaptation of every multipart component of the message must match an input/output element in the list or be included in at least one element of the Include List, described below. Also, under this rule, no multipart component adaptation must be included in any element of the Exclude List, described below. If the rule is not met, the adaptation is deemed to not belong to the class.

Under the “condition met for at least one” rule, the adaptation of any multipart element must match an input/output element in the list or fall in at least one element of the Include List. Also, under this rule, such multipart component adaptation must not be included in any element of the Exclude List. If the rule is not met, the adaptation is deemed to not belong to the class.

It should be noted that if the content to adapt is a single element, as opposed to a multipart elements, then “condition met for all” or “condition met for at least one” are equivalent.

Transcode Permission

Transcode permission describes if the adaptations belonging to this class are allowed or forbidden. It is noted that in a specific standard description, when multiple classes are described, precedence shall be established in case of conflict. For instance, an adaptation operation may be forbidden if it belongs to at least one class for which adaptation is forbidden.

Include List and Exclude List

The Include List defines additional adaptation operations which belong to the class. The additional adaptation operations include generic rules covering many formats. They may include rules that can not be represented by input/output pairs. Some examples of additional adaptation operations include but are not limited to:

Same Format Adaptation. Same Format Adaptation provides for transcoding of content within the same format, such as size/quality reduction, resolution reduction, rotation, rate reduction, frame reduction or the like.

Unsupported Content Dropping. Unsupported Content Dropping provides for the removal of media elements not supported by the mobile terminal or adaptation profile.

Supported Content Dropping. Supported Content Dropping provides for removal of media elements supported by the terminal or adaptation profile.

Other Format Conversion. Other Format Conversion provides for conversion between formats other than those listed in the Input/Output pair.

Image Removal Frame. Image Removal Frame provides for the removal of images frames upon completion of the transcoding process.

Media Truncation. Media Truncation provides for truncation in time of media during transcoding, for example cutting/editing an audio clip.

The Exclude List is a list of additional adaptation operations that do not belong to the class. The additional adaptation operations include generic rules covering many formats. They may include rules that can not be represented by input/output pairs. The same values applied in the Include List are equally applicable as potential Exclude List operations.

As noted above the class parameter/property is mandatory for all standards, while all other parameters/properties are optional. For instance, in a specific standard, such as STI, default values would be set for the optional parameters. For example, in the STI application, be default, the transcode permission parameter may be set to “allowed” and the rule parameter may be set to “condition met for all.”

In the embodiments of the invention in which multiple classes are defined, the intersection of the multiple classes could be empty (i.e., an adaptation operation would belong to 1 class at most) however the empty intersection is not mandatory (i.e., an adaptation operation could belong to many classes).

Referring now to FIG. 3, a flow diagram of a method for defining and determining adaptation permissibility is described. It is noted that adaptation permissibility, otherwise referred to herein as transcode permission, is one of the listed properties in the above list of adaptation properties used to define adaptation classes. The concept of defining and determining adaptation permissibility may be employed in conjunction with defining and determining adaptation classes, as shown in FIG. 2, and it may be employed separately as a stand-alone function. At step 200, adaptation permissibility properties are defined. The permissibility properties may be defined in terms of classes of adaptation, classes of content or any other properties. Thus, the permissibility properties may be defined after defining the classes of adaptation (see FIG. 2, step 100. At step 210, the adaptation permissibility properties are communicated to a transcoding platform. As previously noted the adaptation permissibility properties may be communicated along with adaptation classes (see FIG. 2, step 110), other classes or as separate permissibility properties/rules.

At step 220, a media element, such as a MMS message or the like, that requires adaptation/transcoding is communicated to the transcoding platform and, at step 230, a determination is made, based on the adaptation permissibility properties, as to the permissibility of performing adaptation/transcoding on the media element. It may be possible to grant permission to perform adaptation on one or more classes of adaptation or content while denying adaptation to one more other classes of adaptation or content. At step 240, adaptation/transcoding is performed according to the determined adaptation permissibility properties (see FIG. 2, step 120). Optionally, communication may be sent back to the network application from which the media element was sent notifying the application of the granting or denial of permission to proceed with one or more classes of adaptation/transcoding (see FIG. 2, step 130).

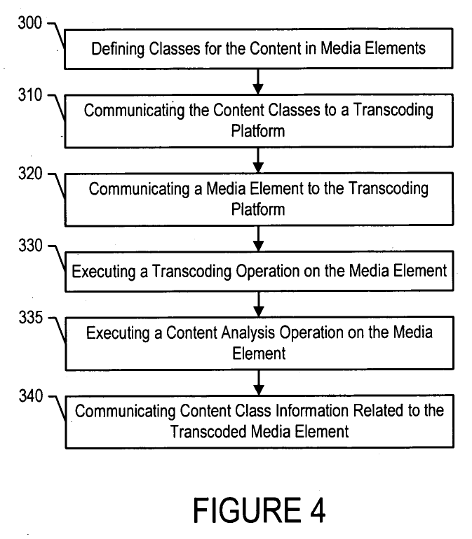

FIG. 4 provides for a flow diagram of a method for classifying content in media elements. Content may be classified prior to transcoding at the network application level or at the transcoding platform, and/or after adaptation/transcoding at the transcoding platform such as for comparison to pre-adaptation content classification at the network application or transcoding platform. At step 300, classes of content for media elements are defined. As with the classes of adaptation, the classes of content may be defined within the network application, although it should be understood that one or more classes of content may alternatively be defined within the transcoding server. At step 310, the defined classes of content, or at least those classes of content defined within the network application, are communicated from the network application to a transcoding application, typically an application-generic transcoding application. Thus, similar to the classes of adaptation, the classes of content may be provided at the transcoding platform, such as by being defined and communicated from the network application and/or by being defined within the transcoding platform. At step 320, a media element, that requires adaptation/transcoding is communicated to the transcoding platform, and at step 330, a transcoding operation is executed at the transcoding platform to adapt/transform a media element. At step 335, before and/or after executing the transcoding operation, a content analysis operation is executed at the transcoding platform on the media element to thereby determine input classes of the content before executing the transcoding operation, and/or output classes of the content after executing the transcoding operation. And, at step 340, the transcoding application communicates, back to the network application, information related to the content class or classes in the adapted/transcoded media element. In accordance with another aspect of the present invention, classes of content are defined by describing their properties. The properties may include, but are not limited to, 1) a class; 2) a list of media content which belong to the class; 3) a rule; and 4) a size limit. The following provides a brief explanation of the content properties and suitable examples:

Class

The class name given to the class of content described. For example, for the MMS application, the class name may be “ImageBasic” “ImageRich” or any other name.

List of Media Content

The list of media content provides for a MIME listing of the types of content which are allowed in the content class.

Rule

The rule portion of the properties list is significant if the message to be adapted includes multiple elements. The rule defines how the list of media content information for each media element shall be processed to determine the content class. In one embodiment the possible values for the rule are “condition met for all” and condition met for at least one.”

Under the “condition met for all” rule, every message component must belong to the list of media content list, otherwise the content of the message is deemed not to belong to the class.

Under the “condition met for at least one” rule, at least one message component must belong to the list of media content list, otherwise the content of the message is deemed no to belong to the class. This rule can be beneficial to determine if a message includes at least one Digital Rights Management (DRM) element.

Size Limit

The size limit indicates the maximum size of the message that can qualify as belonging to a specific content class. If no size limit is specified, the size limit is infinite.

In this regard, FIGS. 2-4 provide for methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowcharts support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems that perform the specified functions or steps, or combinations of special purpose hardware and computer instructions.

In accordance with embodiments of the present invention, the following are examples of adaptations/transcodes performed with classes of adaptation, permissibility and classes of content:

MMSC Representation of Class Adaptations to an STI-Compliant Transcode Routine

The following XML description illustrates how an MMSC could represent minor and major adaptations to an STI-compliant transcoding platform within a request. The response includes a list of adaptation classes which were matched. For instance, the request could have been to transcode a video/h263-2000 clip as needed for a mobile terminal only supporting image/jpeg media format.

Request:

<AdaptationPerformed>

<AdaptationPerformedElement>

<Class> Minor </Class>
<Xcode> Allowed </Xcode>
<Rule> ConditionMetForAll </Rule>
<IncludeList> SameFormatAdaptation,
UnsupportedContentDropping

</IncludeList>

<ExcludeList> SupportedContentDropping,
OtherFormatConversion,

ImageFrameRemoval, MediaTruncation </ExcludeList>

<MimeInOutPair>

<input> image/jpeg </input>
<output> image/jpeg </output>
</MimeInOutPair>
<MimeInOutPair>
<input> audio/amr </input>
<output> audio/13k </output>

</MimeInOutPair>
<MimeInOutPair>

<input> audio/13k </input>
<output> audio/amr </output>

</MimeInOutPair>
<MimeInOutPair>

<input> video/mp4v-es </input>
<output> video/h263-2000, video/mp4v-es </output>

</MimeInOutPair>
<MimeInOutPair>

<input> image/gif </input>
<output> image/gif,image/jpeg </output>

</MimeInOutPair>
<MimeInOutPair>

<input> image/wbmp</input>
<output> image/gif,image/jpeg </output>

</MimeInOutPair>
<MimeInOutPair>

<input> video/h263-2000 </input>
<output> video/h263-2000, video/mp4v-es </output>

</MimeInOutPair>

</AdaptationPerformedElement>
<AdaptationPerformedElement>

<Class> Major </Class>
<Xcode> Forbidden </Xcode>
<Rule> ConditionMetForAtLeastOne </Rule>
<IncludeList> SupportedContentDropping </IncludeList>
<MimeInOutPair>

<input> audio/sp-midi </input>
<output> audio/13k, audio/amr </output>

</MimeInOutPair>
<MimeInOutPair>

<input> audio/midi </input>
<output> audio/sp-midi, audio/amr, audio/13k</output>

</MimeInOutPair>
<MimeInOutPair>

<input> video/mp4v-es </input>
<output> image/gif,image/jpeg </output>

</MimeInOutPair>
<MimeInOutPair>

<input> video/h263-2000, video/h263* </input>
<output> image/gif,image/jpeg </output>

</MimeInOutPair>

</AdaptationPerformedElement>

</AdaptationPerformed>
Response:
<AdaptationPerformed>

<AdaptationPerformedResponse>

<Type> Major </Type>

</AdaptationPerformedResponse>

</AdaptationPerformed>

Web Portal Requesting Knowledge of Layout Conversion from HTML to Other Format

Another example would be for a Web Portal that desires to know if layout conversion was performed to convert HTML to any other format of HTML, xHTML or any other text or SMIL; or if any video was converted to an image, or even if images were deleted:

<AdaptationPerformed>

<AdaptationPerformedElement>

<Class> LayoutAdaptation </Class>
<Xcode> Allowed </Xcode>
<Rule> ConditionMetForAtLeastOne </Rule>
<MimeInOutPair>

<input> text/html </input>
<output> text/*, application/smil </output>

</MimeInOutPair>

</AdaptationPerformedElement>
<AdaptationPerformedElement>

<Class> VideoToImage </Class>
<Xcode> Allowed </Xcode>
<Rule> ConditionMetForAtLeastOne </Rule>
<MimeInOutPair>

<input> video/* </input>
<output> image/* </output>

<MimeInOutPair>

</AdaptationPerformedElement>
<AdaptationPerformedElement>

<Class> ImageDeletion </Class>
<Xcode> Allowed </Xcode>
<Rule> ConditionMetForAtLeastOne </Rule>
<MimeInOutPair>

<input> image/* </input>
<output> </output>

</MimeInOutPair>

</AdaptationPerformedElement>

</AdaptationPerformed>

If the content adapted met the first two classes conditions, the returned response would include:

Response:

<AdaptationPerformed>

<AdaptationPerformedResponse>

<Type> LayoutAdaptation , VideoToImage </Type>

</AdaptationPerformedResponse>

</AdaptationPerformed>

MMSC Representation of MMS Message Classes to an STI-Compliant Transcoding Routine

The following XML description provides an example of how an MMSC could represent the MMS message classes to an STI-compliant transcoding platform within a request. The response includes list of message classes which have been matched. For instance, the initial request could have been to transcode a 300 kB video/h263-2000 clip (VideoRich) as needed for a mobile terminal supporting up to 100 kB video/h263-2000 clip. The result will be a video/1263-2000 clip of less than 100 kB (VideoBasic, VideoRich).

Request:

<ContentClass>

<ContentClassElement>

<Class> ImageBasic </Class>
<Rule> ConditionMetForAll </Rule>
<SizeLimit> 30000 </SizeLimit>
<ContentTypeList>

text/plain; charset=“us-ascii,” text/plain; charset=“UTF-8,”

image/jpeg, image/gif, image/wbmp, audio/amr, audio13k,
text/x-vCard, text/x-vCalendar,application/smil

</ContentTypeList>

</ContentClassElement>
<ContentClassElement>

<Class> ImageRich </Class>
<Rule> ConditionMetForAll </Rule>
<SizeLimit> 100000 </SizeLimit>
<ContentTypeList>

text/plain; charset=“us-ascii,” text/plain; charset=“UTF-8,”

image/jpeg, image/gif, image/wbmp, audio/amr, audio13k,
text/x-vCard, text/x-vCalendar,application/smil,
audio/sp-midi, audio/midi,
application/vnd.oma.drm.message

</ContentTypeList>

</ContentClassElement>
<ContentClassElement>

<Class> VideoBasic </Class>
<Rule> ConditionMetForAll </Rule>
<SizeLimit> 100000 </SizeLimit>
<ContentTypeList>

text/plain; charset=“us-ascii,” text/plain; charset=“UTF-8,”

image/jpeg, image/gif, image/wbmp, audio/amr, audio13k,
text/x-vCard, text/x-vCalendar,application/smil,
audio/sp-midi, audio/midi,
application/vnd.oma.drm.message, video/3gpp, video/3gp2

</ContentTypeList>

</ContentClassElement>
<ContentClassElement>

<Class> VideoRich </Class>
<Rule> ConditionMetForAll </Rule>
<SizeLimit> 300000 </SizeLimit>
<ContentTypeList>

text/plain; charset=“us-ascii,” text/plain; charset=“UTF-8,”

image/jpeg, image/gif, image/wbmp, audio/amr, audio13k,
text/x-vCard, text/x-vCalendar,application/smil,/
audio/sp-midi, audio/midi,
application/vnd.oma.drm.message, video/3gpp, video/3gp2

</ContentTypeList>

</ContentClassElement>

</ContentClass>
Response:
<ContentClass>

<ContentClassElementResponse>

<Input>

<Class> VideoRich </Class>

</Input>
<Output>

<Class> VideoBasic </Class>
<Class> VideoRich </Class>

</Output>

</ContentClassElementResponse>

</ContentClass>

Thus, the present invention provides for a generic method and means for defining and identifying classes of adaptation in transcoding processes. The generic nature of the method and means allow for description of large quantity of adaptation classes, which would accommodate MMS, as well as other network applications.

In addition, the method and means provide for network application to communicate the defined classes of adaptation to a transcoding routine along with an indication as to whether adaptation of content belonging to such classifications are permitted or denied. The method and means also provide for the transcoding routine to communicate to the network application information about the adaptation performed in relation to the classification. This enables the network application to act base on the performed adaptation. Additionally, the present invention provides for methods and means for defining content classes and communicating from transcoding routine to the network application the content class of both input and output message content. This enables the network application to act base on the input and output message content.

The invention proposes a generic framework allowing an application platform to describe “adaptation classes” and “content classes” and their properties. The framework can describe the properties of “minor” and “major” adaptations for MMS application. Because the framework is general, the invention can describe other adaptation classes and content classes of interest in other applications (e.g., describing the properties of a layout adaptation or a video to image adaptation class). The framework also provides the functionality to tell the transcoding platform if those classes of adaptation are permitted or not. This functionality is useful to certain applications, such as MMS, to provide major adaptation disablement functionality. The invention also provides for the application platform to return along with the adapted content, information about the classes of adaptations performed (e.g., if a minor or major adaptation was performed)

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limiting the scope of the present invention in any way.

That which is claimed:

1. A method for communicating adaptation classification in an application-generic transcoding environment, the method comprising the steps of:
providing one or more classes of adaptation at an application-generic transcoding platform;
executing a transcoding operation at the transcoding platform on at least one media element; and
communicating, to a network application, adaptation class-related information including information related to one or more classes of adaptation to which at least one media element was subjected during execution of the transcoding operation.

2. The method of claim 1, wherein the step of providing one or more classes of adaptation includes receiving one or more classes of adaptation through a Standard Transcode Interface.

3. The method of claim 1, wherein the step of communicating adaptation class-related information comprises communicating adaptation class-related information through a Standard Transcode Interface.

4. The method of claim 1, wherein the step of providing one or more classes of adaptation comprises providing one or more classes of adaptation having been defined based on adaptation properties.

5. The method of claim 4, wherein the step of providing one or more classes of adaptation comprises providing one or more classes of adaptation having been defined based on adaptation properties including one or more properties chosen from the group consisting of a class name, a list of input/output pairs, a rule, transcode permission, an include list and an exclude list.

6. A method for determining adaptation permissibility in an application-generic transcoding environment, the method comprising the step of:
receiving adaptation permissibility properties for one or more classes of adaptation, the properties being received at an application-generic transcoding platform;
determining adaptation permissibility for at least one media element based on the received adaptation permissibility properties; and
executing a transcoding operation at the transcoding platform on at least one media element, the transcoding operation being performed in accordance with the determined adaptation permissibility.

7. The method of claim 6, wherein the step of receiving adaptation permissibility properties comprises receiving adaptation permissibility properties through a Standard Transcode Interface.

8. A method for classifying content in media elements in an application-generic transcoding environment, the method comprising:
providing one or more classes for content in media elements, the content classes being provided at an application-generic transcoding platform;
executing a content analysis operation at the transcoding platform on content in at least one media element, the content analysis operation being performed to determine at least one of at least one input class of the content, or at least one output class of the content; and
communicating information related to at least one of the input or output classes of the content.

9. The method of claim 8, wherein the step of providing one or more classes includes receiving one or more classes through a Standard Transcode Interface.

10. A computer program product for communicating the classes to an application-generic transcoding platform, the product comprising a computer readable storage medium having computer-readable program instructions embodied in the medium, the computer-readable program instructions comprising:
first instructions for providing one or more classes of adaptation at an application-generic transcoding platform;
second instructions for executing a transcoding operation at the transcoding platform on at least one media element; and
third instructions for communicating, to a network application, adaptation class-related information including information related to one or more classes of adaptation to which the at least one media element was subjected during execution of the transcoding operation.

11. The computer program product of claim 10, wherein the first instructions are adapted to receive one or more classes of adaptation through a Standard Transcode Interface to thereby provide one or more classes of adaptation.

12. The computer program product of claim 10, wherein the third instructions are adapted to communicate adaptation class-related information through a Standard Transcode Interface.

13. The computer program product of claim 10, wherein the first instructions are adapted to provide one or more classes of adaptation having been defined based on adaptation properties.

14. The computer program product of claim 13, wherein the first instructions are adapted to provide one or more classes of adaptation having been defined based on adaptation properties including one or more properties chosen from the group consisting of a class name, a list of input/output pairs, a rule, transcode permission, an include list and an exclude list.

15. A computer program product for determining adaptation permissibility in an application-generic transcoding environment, the product comprising a computer readable storage medium having computer-readable program instructions embodied in the medium, the computer-readable program instructions comprising:
first instructions for receiving adaptation permissibility properties for one or more classes of adaptation, the properties being received at an application-generic transcoding platform;
second instructions for determining adaptation permissibility for at least one media element based on the received adaptation permissibility properties; and
third instructions for executing a transcoding operation at the transcoding platform on at least one media element, the transcoding operation being performed in accordance with the determined adaptation permissibility.

16. The computer program product of claim 15, wherein the first instructions are adapted to receive adaptation permissibility properties through a Standard Transcode Interface.

17. A computer program product for classifying content in media elements in an application-generic transcoding environment, the product comprising a computer readable storage medium having computer-readable program instructions embodied in the medium, the computer-readable program instructions comprising:
first instructions for providing one or more classes for content in media elements, the content classes being provided at an application-generic transcoding platform;
second instructions for executing a content analysis operation at the transcoding platform on content in at least one media element, the content analysis operation being performed to determine at least one of at least one input class of the content, or at least one output class of the content; and
third instructions for communicating information related to at least one of the input or output classes of the content.

18. The computer program product of claim 17, wherein the first instructions are adapted to receive one or more classes through a Standard Transcode Interface to thereby provide one or more classes for content.
